(19) United States
(12) Patent Application Publication
(10) Pub. No.: US 2008/0006650 A1
(43) Pub. Date: Jan. 10, 2008

(54) Method and apparatus for multi-chamber exhaust control

(75) Inventors: Ming-Kuei Tseng, San Jose, CA (US); Natarajan Ramanan, San Jose, CA (US); Tetsuya Ishikawa, Saratoga, CA (US); Sudhir R. Gondhalekar, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 11/475,687

(22) Filed: Jun. 27, 2006

(51) Int. Cl. G01F 11/00; B67B 7/00

(52) U.S. Cl. 222/1

(57) ABSTRACT

A method of operating a multi-chamber module including a first chamber, a second chamber, and a dispense arm area positioned between the first chamber and the second chamber. The method includes flowing a process gas into the first chamber, the second chamber, and the dispense arm area. The method also includes exhausting a first gas from the first chamber using a first exhaust path in fluid communication with a shared exhaust, exhausting a second gas from the second chamber using a second exhaust path in fluid communication with the shared exhaust, and exhausting a third gas from the dispense arm area using a dispense arm area exhaust in fluid communication with the shared exhaust. The method further includes monitoring a first chamber pressure in the first chamber, a second chamber pressure in the second chamber, and a dispense pressure in the dispense arm area, and adjusting a flow through at least one of the first exhaust path, the second exhaust path, and the dispense arm area exhaust to maintain the first chamber pressure and the second chamber pressure at a value higher than the dispense pressure.

### BACKGROUND OF THE INVENTION

The present invention generally relates to the field of semiconductor processing equipment. More particularly, the present invention relates to a multi-chamber semiconductor processing system including a multi-chamber exhaust system. But it will be appreciated that the invention has a much broader range of applicability.

Modern integrated circuits contain millions of individual elements that are formed by patterning various layers including silicon, metal and/or dielectric layers. The technique used throughout the industry for forming such patterns is photolithography. A typical photolithography process sequence generally includes depositing one or more uniform photoresist layers on the surface of a substrate, drying and curing the deposited photoresist layers, patterning the substrate by exposing photoresist layers to electromagnetic radiation, and developing the exposed layers for patterning.

It is common in the semiconductor industry that many of the steps associated with the photolithography process are performed in a multi-chamber processing system, for example, a cluster tool that has the capability to sequentially process semiconductor wafers in a controlled manner. One example of a cluster tool that is used to coat and develop a photoresist material is commonly referred to as a track lithography tool.

Track lithography tools typically include a mainframe that houses multiple chambers or stations dedicated to performing the various tasks associated with lithography processing. There are typically both wet and dry processing chambers within track lithography tools. Wet chambers include coat and develop bowls, while dry chambers include thermal control units that house bake and/or chill plates.

Track lithography tools also frequently include one or more pod/cassette mounting devices, such as an industry standard front opening unified pod (FOUP), to receive substrates from and return substrates to the clean room, multiple substrate transfer robots to transfer substrates between the various chambers/stations of the track tool and an interface that allows the tool to be operatively coupled to a lithography exposure tool in order to transfer substrates into the exposure tool and receive substrates from the exposure tool after the substrates are processed within the exposure tool.

In a multi-chamber processing system, substrates can be processed in a repeatable way in a controlled processing environment. A controlled processing environment has many benefits which include minimizing contamination of the substrate surfaces during transfer and completion of the various substrate processing steps. Processing in a controlled environment thus reduces the number of generated defects and improves device yield.

Generally, two types of processing chamber included in a track lithography tool are substrate coating modules and substrate developing modules, collectively referred to as coat/develop modules. In coat modules, a spin coating process is used to form a layer of photoresist or other coating on an upper surface of a substrate. One method mounts a substrate on a spin chuck, which is rotated at up to several thousand revolutions per minute (RPMs). Several milliliters of a liquid (e.g., photoresist) is applied to a central region of the substrate and the spinning action of the spin chuck disperses the liquid over the surface of the substrate. The coating is processed in subsequent steps to form features on the substrate as is well known to one of skill in the art.

In develop modules, a developer is applied to the surface of the substrate after exposure of the photoresist to electromagnetic radiation under a mask. The coat/develop modules contain a number of similarities, as well as differences, including different nozzle designs corresponding to varying viscosities of dispense fluids, among other factors.

These coat/develop processes are sensitive to ambient temperature and pressure inside each chamber. Semiconductor processing chambers included in track lithography tools commonly utilize coupled exhaust systems to maintain desired pressure levels within each chamber and to evacuate the chambers of undesired materials.

One problem that can occur in these coat/develop chambers is that variations in exhaust flow within the bowl area of a chamber may cause pressure variations measurable from wafer-to-wafer. These temporal pressure variations will generally result in lithography uniformity problems between subsequent wafers. Additionally, for multi-chamber processing systems, variations in exhaust flow from each chamber may cause chamber-to-chamber pressure and/or temperature variations (i.e., cross-talk), resulting in lithography non-uniformities between chambers. Therefore, a need exists in the art for improved multi-chamber exhaust designs that provide a uniform chamber exhaust flow through each bowl area and across a number of chambers.

### SUMMARY OF THE INVENTION

According to the present invention, techniques related to the field of semiconductor processing equipment are provided. More particularly, the present invention relates to a multi-chamber semiconductor processing system including a multi-chamber exhaust system. But it will be appreciated that the invention has a much broader range of applicability.

According to an embodiment of the present invention, a method of operating a multi-chamber module including a first chamber, a second chamber, and a dispense arm area positioned between the first chamber and the second chamber is provided. The method includes flowing a process gas into the first chamber, the second chamber, and the dispense arm area, exhausting a first gas from the first chamber using a first exhaust path in fluid communication with a shared exhaust, and exhausting a second gas from the second chamber using a second exhaust path in fluid communication with the shared exhaust. The method also includes exhausting a third gas from the dispense arm area using a dispense arm area exhaust in fluid communication with the shared exhaust and monitoring a first chamber pressure in the first chamber, a second chamber pressure in the second chamber, and a dispense pressure in the dispense arm area. The method further includes adjusting a flow through at least one of the first exhaust path, the second exhaust path, and the dispense arm area exhaust to maintain the first chamber pressure and the second chamber pressure at a value higher than the dispense pressure.

According to another embodiment of the present invention, a method for operating a multi-chamber module including a first chamber and a second chamber is provided. The method includes flowing a first process gas including at least one of a temperature controlled air or a humidity controlled air into the first chamber and flowing a second process gas including at least one of a temperature controlled air or a humidity controlled air into the second chamber. The method also includes exhausting a first portion of the first process gas from the first chamber through a first bowl exhaust and exhausting a second portion of the first process gas from the first chamber through a first chamber area exhaust. The first bowl exhaust and the first chamber area exhaust are in fluid communication with a first exhaust path in fluid communication with a shared exhaust. The method further includes exhausting a first portion of the second process gas from the second chamber through a second bowl exhaust and exhausting a second portion of the second process gas from the second chamber through a second chamber area exhaust. The second bowl exhaust and the second chamber area exhaust are in fluid communication with a second exhaust path in fluid communication with the shared exhaust. Additionally, the method includes measuring an exhaust flow in the first exhaust path, measuring an exhaust flow in the second exhaust path, adjusting the exhaust flow in the first exhaust path, and adjusting the exhaust flow in the second exhaust path to maintain the exhaust flow in the first exhaust path and the exhaust flow in the second exhaust path within a predetermined percentage of a predetermined flow rate.

According to yet another embodiment of the present invention, a method of method of operating a multi-chamber module including a first chamber and a second chamber with a shared exhaust during semiconductor substrate processing operations is provided. The method includes flowing a process gas including at least one of a temperature controlled air or a humidity controlled air into the first chamber and the second chamber, exhausting the process gas from the first chamber through a first bowl exhaust path in fluid communication with the shared exhaust, and exhausting the process gas from the second chamber through a second bowl exhaust in fluid communication with the shared exhaust. The method also includes measuring a first exhaust flow rate through the first bowl exhaust path, measuring a second exhaust flow rate through the second bowl exhaust path, and modulating a valve assembly coupled to the first bowl exhaust path and a valve assembly coupled to the second bowl exhaust path to maintain the first exhaust flow rate in the second exhaust flow rate and a substantially constant rate

According to an alternative embodiment of the present invention, a semiconductor processing system is provided. The semiconductor processing system includes a first processing chamber including a first bowl exhaust and a first chamber area exhaust. The first bowl exhaust and the first chamber area exhaust form a first chamber exhaust. The semiconductor processing system also includes a second processing chamber including a second bowl exhaust and a second chamber area exhaust. The second bowl exhaust and the second chamber area exhaust form a second chamber exhaust. The semiconductor processing system further includes a dispense arm area positioned between the first processing chamber and the second processing chamber. The dispense arm area includes a dispense arm area exhaust. Additionally, the semiconductor processing system includes a first flow meter adapted to measure a first total exhaust flow through the first chamber exhaust, a second flow meter adapted to measure a second total exhaust flow through the second chamber exhaust, and a first control valve coupled to the first flow meter and to the first chamber area exhaust. The first control valve is adapted to control a flow rate through the first chamber area exhaust. Moreover, the semiconductor processing system includes a second control valve coupled to the second flow meter and to the second chamber area exhaust. The second control valve is adapted to control a flow rate through the chamber area exhaust. According to embodiments, the semiconductor processing system includes a controller adapted to control the first control valve and the second control valve to maintain the first total exhaust flow and the second total exhaust flow within a predetermined percentage of a set point.

According to yet another alternative embodiment of the present invention, a semiconductor processing system having two or more chambers sharing a common exhaust is provided. The semiconductor processing system includes a first processing chamber in fluid communication with a first bowl area exhaust, a first bowl control valve coupled to the first bowl area exhaust, a first bowl flow sensor coupled to the first bowl control valve, a first chamber area exhaust, and a first chamber area control valve coupled to the first chamber area exhaust. The semiconductor processing system also includes a second processing chamber include communication with the second bowl area exhaust, a second bowl control valve coupled to the second bowl area exhaust, a second bowl flow sensor coupled to the second bowl control valve, a second chamber area exhaust, and a second chamber area control valve coupled to the second chamber area exhaust. The semiconductor processing system further includes a first processing chamber flow sensor adapted to measure a first total exhaust flow from the first chamber coupled to the first chamber area control valve, a second processing chamber flow sensor adapted to measure a second total exhaust flow from the second chamber coupled to the second chamber area control valve, and a controller coupled to the first bowl control valve, the second bowl control valve, the first chamber area control valve, and a second chamber area control valve.

Many benefits are achieved by way of embodiments of the present invention over conventional techniques. For example, embodiments of the present invention maintain substantially constant exhaust flow through a bowl are of a processing chamber, enabling the formation of uniform film coatings on a semiconductor wafer. Other embodiments provide substantially equal exhaust flows from processing chambers coupled to a common exhaust system, reducing cross-talk between the processing chambers and enabling the formation of uniform film coatings across processing chambers. Depending upon the embodiment, one or more of these benefits, as well as other benefits, may be achieved. These and other benefits will be described in more detail throughout the present specification and more particularly below in conjunction with the following drawings.

### BRIEF DESCRIPTION OF THE DRAWINGS

FIG. 1 is a simplified plan view of an embodiment of a track lithography tool according to an embodiment of the present invention;

FIG. 2A is a simplified perspective view of a multi-chamber semiconductor processing chamber including a fluid dispensing apparatus according to an embodiment of the present invention;

FIG. 2B is a simplified plan view of a multi-chamber semiconductor processing chamber as shown in FIG. 2A;

FIG. 3 is a simplified cross-sectional view of a multi-chamber processing module with a shared exhaust according to an embodiment of the present invention;

FIG. 4A is a simplified flowchart illustrating a method of operating a multi-chamber processing module with a shared exhaust according to an embodiment of the present invention;

FIG. 4B is a simplified flowchart illustrating a method of operating a multi-chamber processing module with a shared exhaust according to another embodiment of the present invention; and

FIG. 4C is a simplified flowchart illustrating a method of operating a multi-chamber processing module with a shared exhaust according to yet another embodiment of the present invention.

### DETAILED DESCRIPTION OF SPECIFIC EMBODIMENTS

According to the present invention, techniques related to the field of semiconductor processing equipment are provided. More particularly, the present invention relates to a multi-chamber semiconductor processing system with total chamber exhaust monitored and controlled to provide a uniform chamber exhaust across a plurality of chambers. Merely by way of example, the invention has been applied to a multi-chamber exhaust control. However, it would be recognized that the invention has a much broader range of applicability as well.

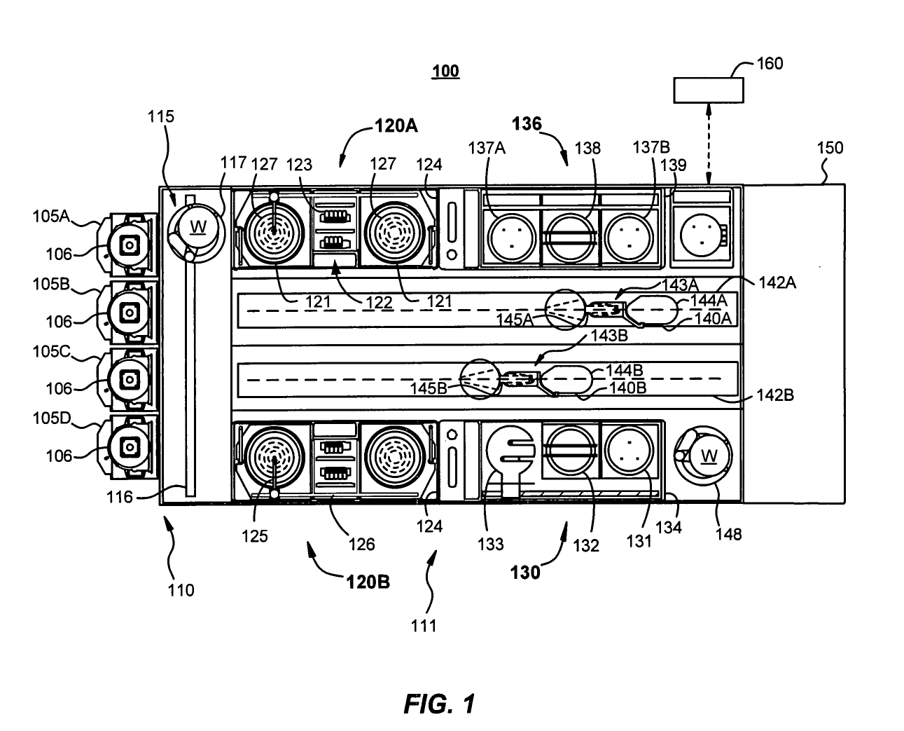

FIG. 1 is a simplified plan view of an embodiment of a track lithography tool 100 in which the embodiments of the present invention may be used. As illustrated in FIG. 1, track lithography tool 100 contains a front end module 210 and a process module 211. In other embodiments, the track lithography tool 100 includes a rear module (not shown), which is sometimes referred to as a scanner interface. Front end module 210 generally contains one or more pod assemblies or FOUPS (e.g., items 105A-D) and a front end robot assembly 115 including a horizontal motion assembly 116 and a front end robot 117. The front end module 210 may also include front end processing racks (not shown). The one or more pod assemblies 105A-D are generally adapted to accept one or more cassettes 106 that may contain one or more substrates or wafers, “W,” that are to be processed in track lithography tool 100. The front end module 210 may also contain one or more pass-through positions (not shown) to link the front end module 210 and the process module 211.

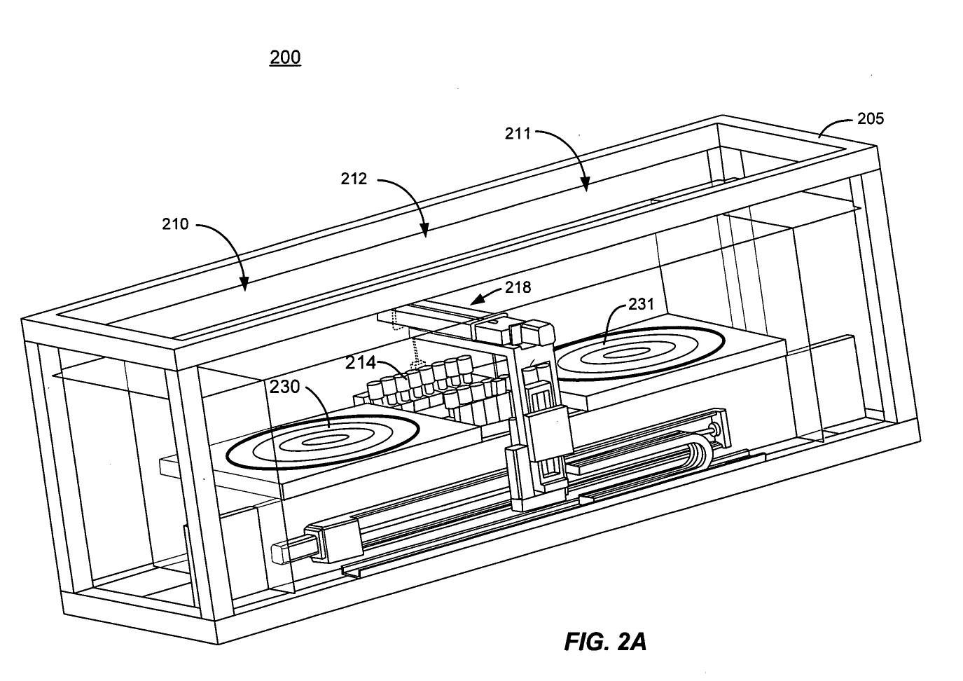

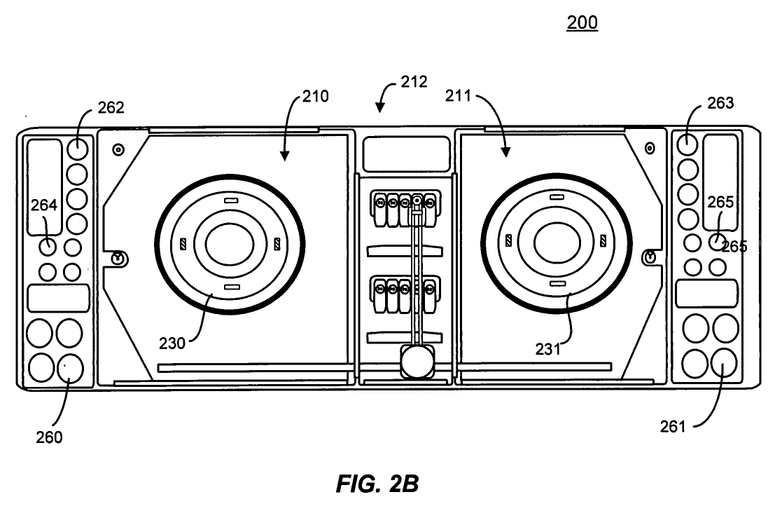

Process module 211 generally contains a number of processing racks 120A, 120B, 230, and 136. As illustrated in FIG. 1, processing racks 120A and 120B each include a coater/developer module with shared dispense 124. A coater/developer module with shared dispense 124 includes two coat bowls 121 positioned on opposing sides of a shared dispense bank 122, which contains a number of nozzles 123 providing processing fluids (e.g., bottom anti-reflection coating (BARC) liquid, resist, developer, and the like) to a wafer mounted on a substrate support 127 located in the coat bowl 121. In the embodiment illustrated in FIG. 1, a dispense arm 125 sliding along a track 126 is able to pick up a nozzle 123 from the shared dispense bank 122 and position the selected nozzle over the wafer for dispense operations. Of course, coat bowls with dedicated dispense banks are provided in alternative embodiments. A schematic perspective view and a schematic plan view of the processing rack 120A or 120B are illustrated in FIG. 2A and FIG. 2B.

Processing rack 230 includes an integrated thermal unit 134 including a bake plate 231, a chill plate 132, and a shuttle 133. The bake plate 231 and the chill plate 132 are utilized in heat treatment operations including post exposure bake (PEB), post-resist bake, and the like. In some embodiments, the shuttle 133, which moves wafers in the x-direction between the bake plate 231 and the chill plate 132, is chilled to provide for initial cooling of a wafer after removal from the bake plate 231 and prior to placement on the chill plate 132. Moreover, in other embodiments, the shuttle 133 is adapted to move in the z-direction, enabling the use of bake and chill plates at different z-heights. Processing rack 136 includes an integrated bake and chill unit 139, with two bake plates 137A and 137B served by a single chill plate 138.

One or more robot assemblies (robots) 140 are adapted to access the front-end module 210, the various processing modules or chambers retained in the processing racks 120A, 120B, 230, and 136, and the scanner 150. By transferring substrates between these various components, a desired processing sequence can be performed on the substrates. The two robots 140 illustrated in FIG. 1 are configured in a parallel processing configuration and travel in the x-direction along horizontal motion assembly 142. Utilizing a mast structure (not shown), the robots 140 are also adapted to move in a vertical (z-direction) and horizontal directions, i.e., transfer direction (x-direction) and a direction orthogonal to the transfer direction (y-direction). Utilizing one or more of these three directional motion capabilities, robots 140 are able to place wafers in and transfer wafers between the various processing chambers retained in the processing racks that are aligned along the transfer direction.

Referring to FIG. 1, the first robot assembly 140A and the second robot assembly 140B are adapted to transfer substrates to the various processing chambers contained in the processing racks 120A, 120B, 230, and 136. In one embodiment, to perform the process of transferring substrates in the track lithography tool 100, robot assembly 140A and robot assembly 140B are similarly configured and include at least one horizontal motion assembly 142, a vertical motion assembly 144, and a robot hardware assembly 143 supporting a robot blade 145. robot assemblies 140 are in communication with a system controller 160. In the embodiment illustrated in FIG. 1, a rear robot assembly 148 is also provided.

The scanner 150, which may be purchased from Canon USA, Inc. of San Jose, Calif., Nikon Precision Inc. of Belmont, Calif., or ASML US, Inc. of Tempe, Ariz., is a lithographic projection apparatus used, for example, in the manufacture of integrated circuits (ICs). The scanner 150 exposes a photosensitive material (resist), deposited on the substrate in the cluster tool, to some form of electromagnetic radiation to generate a circuit pattern corresponding to an individual layer of the integrated circuit (IC) device to be formed on the substrate surface.

Each of the processing racks 120A, 120B, 230, and 136 contain multiple processing modules in a vertically stacked arrangement. That is, each of the processing racks may contain multiple stacked coater/developer modules with shared dispense 124, multiple stacked integrated thermal units 134, multiple stacked integrated bake and chill units 139, or other modules that are adapted to perform the various processing steps required of a track photolithography tool. As examples, coater/developer modules with shared dispense 124 may be used to deposit a bottom antireflective coating (BARC) and/or deposit and/or develop photoresist layers. Integrated thermal units 134 and integrated bake and chill units 139 may perform bake and chill operations associated with hardening BARC and/or photoresist layers after application or exposure.

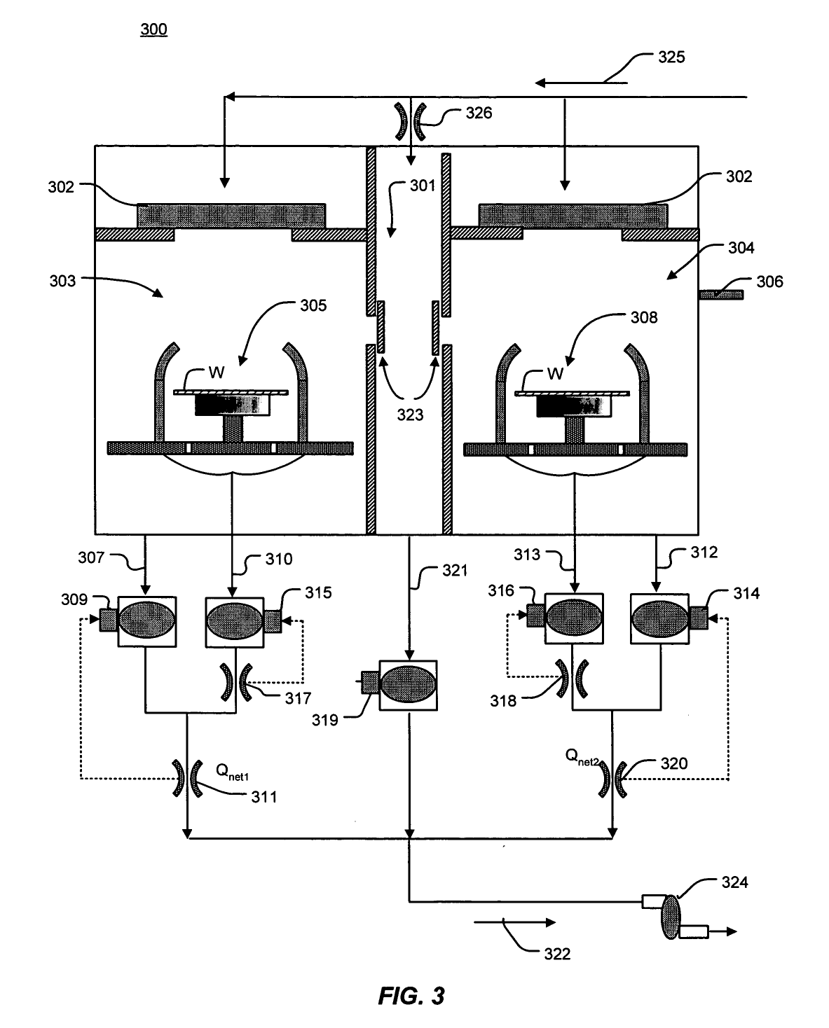

FIG. 2A is a simplified perspective view of a multi-chamber semiconductor processing chamber including a fluid dispensing apparatus according to an embodiment of the present invention. The processing chamber illustrated in FIG. 2A may be utilized, for example, as processing rack 120A or 120B of the track lithography tool shown in FIG. 1. As illustrated in FIG. 2A, fluid dispensing apparatus 200 contains two processing chambers 210 and 211 and central fluid dispense bank 212. In some embodiments, the central fluid dispense bank 212 is referred to as dispense arm area 212 as described more fully below. For purposes of clarity, not all components are illustrated. For example, air intake and exhaust ports are not illustrated in FIG. 2A. Additional details concerning some of the components are provided in FIGS. 2B and 3.

Referring to FIG. 2A, two processing chambers 210 and 211 are located within frame 205 on the left and right sides of a central fluid dispense bank 212. In some coat/develop modules, processing chambers 210 and 211 are referred to as processing stations or processing modules. Herein, the terms processing chamber, processing station, and processing module are used interchangeably.

Merely by way of example, the invention has-been applied to a coat/develop module 200 with a pair of coat/develop bowls horizontally arrayed on either side of a central fluid dispense bank 212. The coat module is a photoresist module with different photoresists as well as photoresists combined with different concentrations of solvents. As will be evident to one of skill in the art, the fluids dispensed by the central fluid dispense bank may be delivered in the form of liquid, vapor, mist, or droplets.

Referring to FIG. 2A, the central fluid dispense bank 212 contains a number of dispense nozzles 214. Each spin chuck 230 and 231 is coupled to a motor (not shown) through a shaft (not shown) and adapted to rotate about an axis perpendicular to the face of the spin chuck. A controller (not shown) is provided and connected to the motors so that the timing and rotation speed of the spin chucks can be controlled in a predetermined manner. The dispense arm assembly 218 is actuated in three dimensions by motors. The motors are selected to provide for motion of the dispense arm assembly with predetermined speed, accuracy, and repeatability.

FIG. 2B is a simplified plan view of a multi-chamber semiconductor processing chamber as shown in FIG. 2A. As illustrated in FIG. 2B, each of the two processing chambers 210 and 211 includes a dispense arm access shutter 222 and 223 positioned between the spin chucks 230, 231 and the central fluid dispense bank 212.

Referring to FIG. 2B, a gas flow distribution system is adapted to deliver a uniform flow of a gas to processing chambers 210 and 211. In addition, the gas flow distribution system is adapted to deliver an additional flow of a gas to the central fluid dispense bank 212. As described in additional detail in relation to FIG. 3, the gas flow distribution system included in embodiments of the present invention provides temperature and/or humidity controlled air through a plurality of supply ports located in the upper part of each chamber.

FIG. 2B illustrates a number of inlet and exhaust ports used to provide temperature and humidity controlled air or other gases to processing chambers 210 and 211. Four supply ports 260 are illustrated in FIG. 2B. According to the embodiment illustrated in FIG. 2B, four multi-chamber semiconductor processing chambers 200 are provided in a vertically stacked arrangement. Thus, at appropriate vertical positions, one of the four supply ports 260 is provided in fluid communication with a corresponding one of the four processing chambers 210. Four chamber area exhausts 262 and four cup drains 264 are also provided for each of the corresponding processing chambers. Since FIG. 2B merely illustrates a simplified schematic diagram, not all details are illustrated for purposes of clarity.

A first chamber area exhaust 262 provides for removal of air and/or vapors from a first portion of the processing chamber 210, referred to as the chamber area, and a first bowl exhaust (not shown) provides for removal of air and/or vapors from the first bowl area 230. As shown in FIG. 2B, matching supply ports 261, chamber area exhausts 263, and bowl exhausts (not shown) are provided for processing chamber 211. As described more fully below, the supply and exhaust flows from the various supply and exhaust ports are monitored and controlled to provide chamber conditions suitable for lithography processing operations.

FIG. 3 is a simplified cross-sectional view of a multi-chamber processing module with a shared exhaust according to an embodiment of the present invention. Referring to FIG. 3, the multi-chamber processing module 300 includes processing chambers 303 and 304, bowl exhausts 310 and 313, and chamber area exhausts 307 and 312.

As discussed above, in some embodiments, multi-chamber processing module 300 is one of several vertically stacked modules. That is, referring to FIG. 1, each of the processing racks 120A/120B may contain multiple stacked spin/coat modules, multiple stacked coat/develop modules with shared dispense (not shown), or other modules that are adapted to perform the various processing steps provided by a track photolithography tool. For example, a spin/coat module may deposit a bottom antireflective coating and other coat/develop modules may be used to deposit and/or develop photoresist layers as already explained above with reference to FIG. 1.

Referring to FIG. 3, temperature and/or humidity controlled air is provided to processing chambers 303 and 304 via supply lines 325 in fluid communication with the processing chambers. As shown in FIG. 3, filters, such as High Efficiency Particulate Air (HEPA) filters 302, are utilized to remove particulates from the air flowing through supply lines 325 into the processing chambers. As will be understood, the removal of particles is desirable to reduce particulate contamination in coatings formed on wafers W processed in the processing chambers 303 and 304. Exhaust gases are removed from the processing chambers 303 and 304 by multiple exhaust ports. Exhaust gases present in the bowl area 305 are removed using bowl exhausts 310 and 313. Exhaust gases present in the portions of the chamber other than the bowl area are removed using chamber area exhausts 307 and 312. Thus, independent exhaust paths are provided for at least two portions of the processing chambers 303 and 304. The dispense arm area 301 is supplied with temperature and/or humidity controlled air by an inlet port coupled to valve 326 and exhausted by exhaust line 321 coupled to valve assembly 319. Booster fan 324 is used to draw the total exhaust flow 322 from each of the processing chambers 303 and 304 and the dispense arm area 323.

Flow meters 317 and 318 are used to measure air flow rate through the bowl exhausts 310 and 313. A valve assembly 315 is coupled to the bowl exhaust 310 and another valve assembly 316 is coupled to bowl exhaust 313. In an embodiment, each of the valve assemblies 315 and 316 include a controller and a valve, for example, a throttle valve controlled by the controller. As described more fully below, flow rates measured by flow meter 317 are utilized in a feedback loop to modulate the flow through the valve assembly 315, thereby adjusting the exhaust flow from the bowl area of processing chamber 303. Similarly, flow rates measured by flow meter 318 are utilized in a feedback loop to modulate the flow through the valve assembly 316, thereby adjusting the exhaust flow from the bowl area of processing chamber 304. Embodiments of the present invention adjust the exhaust flow from the bowl area to maintain a substantially constant bowl exhaust flow. Studies by the inventors have determined that a substantially constant bowl exhaust flow improves coating uniformity in comparison to variable bowl exhaust flows. Without limiting the scope of the present invention, the inventors believe that maintaining a substantially constant flow through the bowl exhausts 310 and 313 contributes to improved wafer-to-wafer thickness uniformity during wafer processing because temporally unstable exhaust flows can affect such process parameters as temperature, humidity, and the like within the bowl area.

In another embodiment of the present invention, the total exhaust flow from each processing chamber 303 and 304 is monitored and controlled to prevent cross-talk among the processing chambers. Referring to FIG. 3, a first total exhaust flow from processing chamber 303, Qnet1, and a second total exhaust flow from processing chamber 304, Qnet2, are measured by the flow meters 311 and 320, respectively. A valve assembly 309 is coupled to the chamber exhaust 307 and another valve assembly 314 is coupled to chamber exhaust 312. In an embodiment, each of the valve assemblies 309 and 314 include a controller and a valve, for example, a throttle valve controlled by the controller.

In an embodiment, flow rates measured by flow meter 311 are utilized in a feedback loop to modulate the flow through the valve assembly 309, thereby adjusting the exhaust flow from the chamber area of processing chamber 303. Similarly, flow rates measured by flow meter 320 are utilized in a feedback loop to modulate the flow through the valve assembly 314, thereby adjusting the exhaust flow from the chamber area of processing chamber 304. Accordingly, the total exhaust flows from each processing chamber 303 (Qₙₑₜ₁) and 304 (Qₙₑₜ₂) are controlled to maintain a substantially balanced exhaust flow in which Qₙₑₜ₁≈Qₙₑₜ₂. In a particular embodiment, Qₙₑₜ₁ and Qₙₑₜ₂ are maintained within 10% of a predetermined flow rate set point in order to prevent cross-talk between processing chambers 303 and 304. One of ordinary skill in the art would recognize many variations, modifications, and alternatives.

For a multi-chamber system where there are more than two chambers, for example, N chambers, a total exhaust flow from each chamber is monitored and controlled as described above to maintain substantially equal exhaust flow among chambers, which can be represented by the following equation: Qₙₑₜ₁=Qₙₑₜ₂=Qₙₑₜ₃= . . . =Q_{netN}.

Referring to FIG. 3, chamber 301, in which the central fluid dispense bank (see reference number 212 in FIG. 2B) is located, is separated from processing chambers 303 and 304 by dispense arm access shutters 323. The chamber is 301 is also referred to herein as a dispense arm area 301. The pressures in processing chambers 303 and 304 are typically impacted by the opening and/or closing of dispense arm access shutters 323, which are utilized to provide a transit space for the dispense arm 218 as illustrated in FIG. 2A. As part of the technique of maintaining substantially equal exhaust flow among chambers, the flow of air through dispense arm access shutters 323 is accounted for in the adjustments to valve assemblies 309, 315, 316, and 314, maintaining the bowl exhaust flow consistent over time and balancing the chamber area exhausts to maintain the total exhaust flow from each processing chamber at a substantially equal level.

Provision of temperature and/or humidity controlled gas, for example, air, to the processing chambers generally extends to the monitoring and control of various air flow parameters. The environment of the processing chamber is monitored and parameters including the solvent partial pressure, vapor concentration, air flow velocity, air flow rate, differential pressure, and the like, are controlled to achieve the desired air pressure, temperature, and humidity in the processing chambers. In an embodiment, the pressure inside each processing chamber 303 and 304 and dispense arm area 301 is monitored using a pressure sensor 306. A pressure in the processing chamber (P_{c}) and a pressure in the dispense arm area pressure (P_{d}) are monitored and maintained in a predetermined relationship through the use of the combination of air intake and exhaust system described throughout the present specification.

In a specific embodiment, the pressures in the dispense arm area (P_{d}) and in the bowl area (P_{c}) are measured using one or more sensors such as pressure sensor 306. The exhaust flow through the dispense arm area exhaust line 321 is adjusted using control valve assembly 319 to maintain the pressures in the processing chambers (P_{c1}, P_{c2}) (in a particular embodiment, the bowl areas) at a pressure higher than the pressure in the dispense arm area 301 (P_{d}). The pressure in the dispense arm area (P_{d}) is maintained at a higher pressure than atmospheric pressure. Thus, embodiments of the present invention provide for the pressures in the processing chambers and the dispense arm area that are represented by the following equation: P_{c}>P_{d}>Pₐₜₘ. Maintaining the pressure in the processing chambers (in particular embodiments, the bowl areas) higher than the pressure in the dispense arm area prevents any particles present in the air passing through the dispense arm areas from passing to the processing chambers 303 and 304.

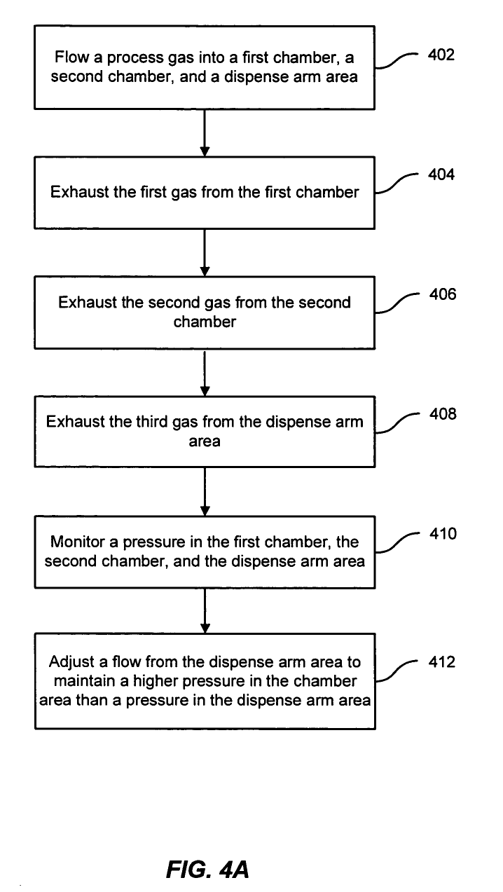

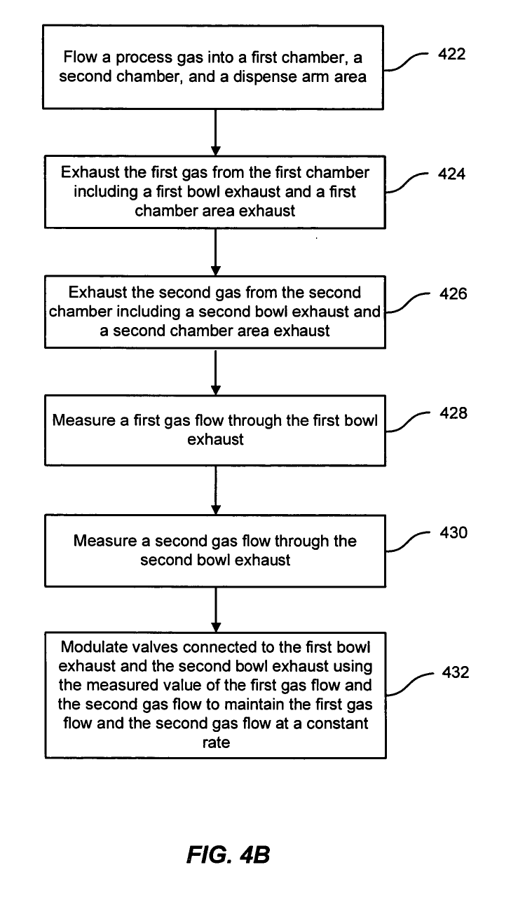

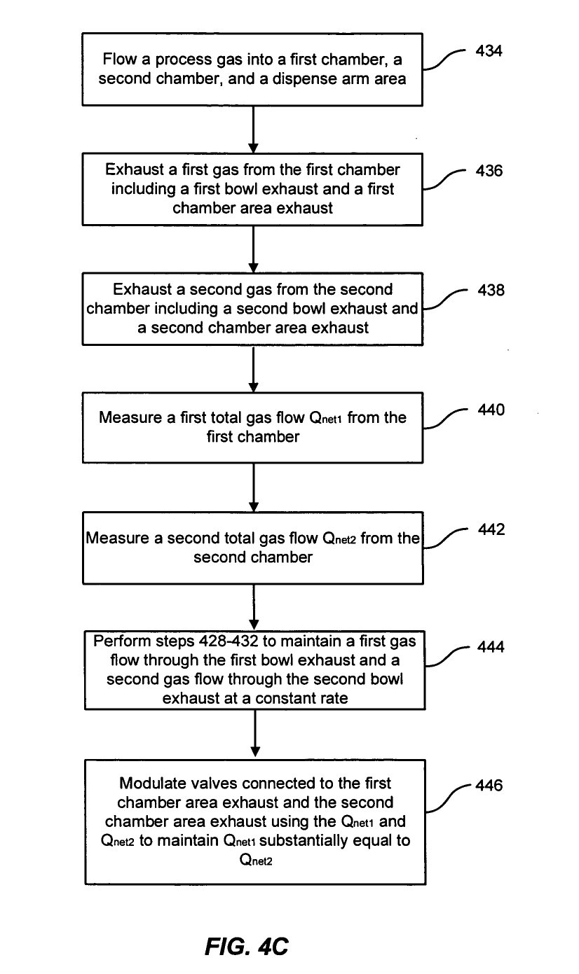

FIG. 4A is a simplified flowchart illustrating a method of operating a multi-chamber processing module with a shared exhaust according to an embodiment of the present invention. A first process gas is supplied to a first processing chamber, a second process gas is supplied to a second processing chamber, and a third process gas is provided to a dispense arm area (402). In an embodiment, the first, the second, and the third process gases are temperature and/or humidity controlled air. The first process gas and the second process gas are exhausted from the first and second process chambers (404, 406). The third process gas is exhausted from the dispense arm area (408). A pressure is measured in the first and second process chambers and in the dispense arm area (410). The exhaust flow from the dispense arm area is adjusted to maintain a higher pressure in the first processing chamber and the second processing chambers than a pressure in the dispense arm area. Thus, the methods and techniques prevent the introduction of particles from the dispense arm area into the processing chambers.

The above sequence of steps provides a method of operating a multi-chamber processing module according to an embodiment of the present invention. As shown, the method uses a combination of steps including a way of measuring and maintaining chamber pressures according to an embodiment of the present invention. Other sequences of steps may also be performed according to alternative embodiments. Moreover, the individual steps illustrated by FIG. 4A may include multiple sub-steps that may be performed in various sequences as appropriate to the individual step. Furthermore, other alternatives can also be provided where steps are added, one or more steps are removed, or one or more steps are provided in a different sequence without departing from the scope of the claims herein. One of ordinary skill in the art would recognize many variations, modifications, and alternatives.

FIG. 4B is a simplified flowchart illustrating a method of operating a multi-chamber processing module with a shared exhaust according to another embodiment of the present invention. A first process gas is provided to a first processing chamber, a second process gas is provided to a second processing chamber, and a third process gas is provided to a dispense arm area (422). In an embodiment, the first, the second, and the third process gases are temperature and/or humidity controlled air. The first process gas is exhausted from the first processing chamber through a first bowl exhaust and a first chamber area exhaust (424). The second process gas is exhausted from the second processing chamber through a second bowl exhaust and a second chamber area exhaust (426). The exhaust flow of the first process gas through the first bowl exhaust is measured (428). The exhaust flow of the second process gas through the second bowl exhaust is measured (430). Valves connected to the first bowl exhaust and the second bowl exhaust are modulated, based in part, on the measured exhaust flows of the first and second process gases, to maintain the first process gas flow and the second process gas flow at a substantially constant rate.

The above sequence of steps provides a method of operating a multi-chamber processing module according to another embodiment of the present invention. As shown, the method uses a combination of steps including a way of measuring and maintaining process gas flow rates according to an embodiment of the present invention. Other sequences of steps may also be performed according to alternative embodiments. Moreover, the individual steps illustrated by FIG. 4B may include multiple sub-steps that may be performed in various sequences as appropriate to the individual step. Furthermore, other alternatives can also be provided where steps are added, one or more steps are removed, or one or more steps are provided in a different sequence without departing from the scope of the claims herein. One of ordinary skill in the art would recognize many variations, modifications, and alternatives.

FIG. 4C is a simplified flowchart illustrating a method of operating a multi-chamber processing module with a shared exhaust according to yet another embodiment of the present invention. A first process gas is provided to a first processing chamber, a second process gas is provided to a second processing chamber, and a third process gas is provided to a dispense arm area (434). In an embodiment, the first, the second, and the third process gases are temperature and/or humidity controlled air. A first portion of the first process gas is exhausted through a first bowl exhaust and a second portion of the first process gas is exhausted through a first chamber area exhaust (436). In some embodiments, the first portion and the second portion total to the amount of the first process gas, whereas in other embodiments, a portion of the first process gas is exhausted through the dispense arm area.

A first portion of the second process gas is exhausted through a second bowl exhaust and a second portion of the second process gas is exhausted through a second chamber area exhaust (438). In some embodiments, the first portion and the second portion total to the amount of the second process gas, whereas in other embodiments, a portion of the second process gas is exhausted through the dispense arm area. The combined gas exhaust flow through the first bowl exhaust and the first chamber area exhaust is measured (440) and the combined gas exhaust flow through the second bowl exhaust and the second chamber area exhaust is measured (442).

According to embodiments of the present invention, techniques as described in relation to steps 428 through 432 shown in FIG. 4B, flows through the bowl exhausts are maintained at a substantially constant rate. For these embodiments, the combined exhaust flows from each processing chamber are controlled by modulating valves connected to the first chamber area exhaust and the second chamber area exhaust based, in part, on the measurements of the combined exhaust flows from the first and second processing chambers. According to a specific embodiment, the combined exhaust flows from the first processing chamber and the second processing chamber are controlled within a predetermined percentage of a predetermined set point to prevent cross-talk among the processing chambers. In a specific embodiment, the combined exhaust flows from the first processing chamber and the second processing chamber are controlled within a predetermined percentage of a predetermined set point. Merely by way of example, in a particular embodiment, the combined exhaust flows from the first processing chamber and the second processing chamber are controlled within 10% of a predetermined set point. In other embodiments, the predetermined percentage is less than or equal to 10%. Of course, the particular predetermined percentage will depend on the particular applications. One of ordinary skill in the art would recognize many variations, modifications, and alternatives.

The above sequence of steps provides a method of operating a multi-chamber processing module according to yet another embodiment of the present invention. As shown, the method uses a combination of steps including a way of measuring and maintaining process gas flow rates according to an embodiment of the present invention. Other sequences of steps may also be performed according to alternative embodiments. Moreover, the individual steps illustrated by FIG. 4C may include multiple sub-steps that may be performed in various sequences as appropriate to the individual step. Furthermore, other alternatives can also be provided where steps are added, one or more steps are removed, or one or more steps are provided in a different sequence without departing from the scope of the claims herein. One of ordinary skill in the art would recognize many variations, modifications, and alternatives.

While the present invention has been described with respect to particular embodiments and specific examples thereof, it should be understood that other embodiments may fall within the spirit and scope of the invention. The scope of the invention should, therefore, be determined with reference to the appended claims along with their full scope of equivalents.

What is claimed is:

1. A method of operating a multi-chamber module including a first chamber, a second chamber, and a dispense arm area positioned between the first chamber and the second chamber, the method comprising:
flowing a process gas into the first chamber, the second chamber, and the dispense arm area;
exhausting a first gas from the first chamber using a first exhaust path in fluid communication with a shared exhaust;
exhausting a second gas from the second chamber using a second exhaust path in fluid communication with the shared exhaust;
exhausting a third gas from the dispense arm area using a dispense arm area exhaust in fluid communication with the shared exhaust;
monitoring a first chamber pressure in the first chamber, a second chamber pressure in the second chamber, and a dispense pressure in the dispense arm area; and
adjusting a flow through at least one of the first exhaust path, the second exhaust path, and the dispense arm area exhaust to maintain the first chamber pressure and the second chamber pressure at a value higher than the dispense pressure.

2. The method of claim 1 wherein the process gas comprises at least one of a temperature controlled air or a humidity controlled air.

3. The method of claim 1 wherein the dispense pressure is higher than an atmospheric pressure.

4. The method of claim 1 wherein the temperature and/or humidity controlled air is provided to the first chamber and second chamber through a HEPA filter in fluid communication with the first chamber and the second chamber.

5. The method of claim 1 wherein adjusting a flow further comprises modulating a control valve in fluid communication with the dispense arm area exhaust.

6. A method for operating a multi-chamber module including a first chamber and a second chamber, the method comprising:
flowing a first process gas including at least one of a temperature controlled air or a humidity controlled air into the first chamber;
flowing a second process gas including at least one of a temperature controlled air or a humidity controlled air into the second chamber;
exhausting a first portion of the first process gas from the first chamber through a first bowl exhaust;
exhausting a second portion of the first process gas from the first chamber through a first chamber area exhaust, wherein the first bowl exhaust and the first chamber area exhaust are in fluid communication with a first exhaust path in fluid communication with a shared exhaust;
exhausting a first portion of the second process gas from the second chamber through a second bowl exhaust;
exhausting a second portion of the second process gas from the second chamber through a second chamber area exhaust, wherein the second bowl exhaust and the second chamber area exhaust are in fluid communication with a second exhaust path in fluid communication with the shared exhaust;
measuring an exhaust flow in the first exhaust path;
measuring an exhaust flow in the second exhaust path;
adjusting the exhaust flow in the first exhaust path; and
adjusting the exhaust flow in the second exhaust path to maintain the exhaust flow in the first exhaust path and the exhaust flow in the second exhaust path within a predetermined percentage of a predetermined flow rate.

7. The method of claim 6 wherein the predetermined percentage is less than or equal to 10%.

8. The method of claim 7 wherein the predetermined percentage is less than or equal to 5%.

9. The method of claim 6 further comprising:
adjusting the exhaust flow in the first exhaust path; and
adjusting the exhaust flow in the second exhaust path to maintain the exhaust flow in the first exhaust path and the exhaust flow in the second exhaust path at substantially equal flow rates.

10. The method of claim 6 wherein adjusting the exhaust flow in the first exhaust path is based, in part, on the measurement of the exhaust flow in the first exhaust path.

11. The method of claim 10 wherein adjusting the exhaust flow in the first exhaust path further comprises modulating a valve in fluid communication with the first chamber area exhaust.

12. The method of claim 6 further comprising:
measuring an exhaust flow through the first bowl exhaust;
measuring an exhaust flow through the second bowl exhaust;
modulating a valve in fluid communication with the first bowl exhaust; and
modulating a valve in fluid communication with the second bowl exhaust in response to the measured exhaust flow through the first bowl exhaust and the measured exhaust flow through the second bowl exhaust, thereby maintaining a substantially constant exhaust flow through the first bowl exhaust and the second bowl exhaust.

13. A method of operating a multi-chamber module including a first chamber and a second chamber with a shared exhaust during semiconductor substrate processing operations, the method comprising:
flowing a process gas including at least one of a temperature controlled air or a humidity controlled air into the first chamber and the second chamber;
exhausting the process gas from the first chamber through a first bowl exhaust path in fluid communication with the shared exhaust;
exhausting the process gas from the second chamber through a second bowl exhaust in fluid communication with the shared exhaust;
measuring a first exhaust flow rate through the first bowl exhaust path;
measuring a second exhaust flow rate through the second bowl exhaust path; and
modulating a valve assembly coupled to the first bowl exhaust path and a valve assembly coupled to the second bowl exhaust path to maintain the first exhaust flow rate in the second exhaust flow rate and a substantially constant rate

14. The method of claim 13 wherein modulating a valve assembly coupled to the first bowl exhaust path and a valve assembly coupled to the second bowl exhaust path is performed in response to at least one of the first exhaust flow rate for the second exhaust flow rate.

15. The method of claim 13 wherein the valve assembly coupled to the first bowl exhaust path in the valve assembly coupled to the second bowl exhaust path each comprise a controller and a valve.

16. A semiconductor processing system comprising:
a first processing chamber including a first bowl exhaust and a first chamber area exhaust, the first bowl exhaust and the first chamber area exhaust forming a first chamber exhaust;
a second processing chamber including a second bowl exhaust and a second chamber area exhaust, the second bowl exhaust and the second chamber area exhaust forming a second chamber exhaust;
a dispense arm area positioned between the first processing chamber and the second processing chamber, the dispense arm area including a dispense arm area exhaust;
a first flow meter adapted to measure a first total exhaust flow through the first chamber exhaust;
a second flow meter adapted to measure a second total exhaust flow through the second chamber exhaust;
a first control valve coupled to the first flow meter and to the first chamber area exhaust, wherein the first control valve is adapted to control a flow rate through the first chamber area exhaust;
a second control valve coupled to the second flow meter and to the second chamber area exhaust, where in the second control valve is adapted to control a flow rate through the chamber area exhaust;
a controller adapted to control the first control valve and the second control valve to maintain the first total exhaust flow and the second total exhaust flow within a predetermined percentage of a set point.

17. The semiconductor processing system of claim 16 wherein the first processing chamber and the second processing chamber comprise processing chambers of a track lithography tool.

18. The semiconductor processing system of claim 16 wherein the dispense arm area provides a processing space for fluid dispense apparatus.

19. The semiconductor processing system of claim 18 wherein the fluid dispense apparatus comprises photoresist dispense apparatus.

20. The semiconductor processing system of claim 16 wherein the predetermined percentage is 10%.

21. The semiconductor processing system of claim 20 wherein the predetermined percentage is 5%.

22. The semiconductor processing system of claim 21 wherein the predetermined percentage is 1%.

23. The semiconductor processing system of claim 16 wherein the controller is adapted to utilize data from the first flow meter and the second flow meter.

24. A semiconductor processing system having two or more chambers sharing a common exhaust, the semiconductor processing system comprising:
a first processing chamber in fluid communication with a first bowl area exhaust, a first bowl control valve coupled to the first bowl area exhaust, a first bowl flow sensor coupled to the first bowl control valve, a first chamber area exhaust, and a first chamber area control valve coupled to the first chamber area exhaust,
a second processing chamber include communication with the second bowl area exhaust, a second bowl control valve coupled to the second bowl area exhaust, a second bowl flow sensor coupled to the second bowl control valve, a second chamber area exhaust, and a second chamber area control valve coupled to the second chamber area exhaust;
a first processing chamber flow sensor adapted to measure a first total exhaust flow from the first chamber coupled to the first chamber area control valve;
a second processing chamber flow sensor adapted to measure a second total exhaust flow from the second chamber coupled to the second chamber area control valve; and
a controller coupled to the first bowl control valve, the second bowl control valve, the first chamber area control valve, and a second chamber area control valve.

25. The semiconductor processing system of claim 24 were in a controller is adapted to provide control signals used to maintain the first total exhaust flow in the second total exhaust flow within a predetermined percentage of a predetermined set point.

26. The semiconductor processing system of claim 24 further comprising a dispense arm area sharing the common exhaust and in fluid communication with a dispense arm area control valve.
